(19) United States
(12) Patent Application Publication
(10) Pub. No.: US 2026/0154563 A1
(43) Pub. Date: Jun. 4, 2026

(54) REINFORCEMENT LEARNING SYSTEM FOR RESOURCE-CONSTRAINED LANGUAGE MODEL

(71) Applicant: Saikiran Rallabandi, Round Rock, TX (US)

(72) Inventor: Saikiran Rallabandi, Round Rock, TX (US)

(21) Appl. No.: 19/457,288

(22) Filed: Jan. 23, 2026

(51) Int. Cl. G06N 3/092

(52) U.S. Cl. CPC G06N 3/092

(57) ABSTRACT

The present disclosure relates to a reinforcement learning system for resource-constrained language models. A generated output from a small language model is evaluated using a plurality of reward components comprising a syntax reward component, a semantic reward component, and a structure reward component. The reward components are weighted and aggregated to compute a composite reward signal that is used to update parameters of the small language model through reinforcement learning. The system enables direct optimization of small language models having sub-billion parameter counts by providing dense and domain-specific training feedback. The system is applied to Infrastructure-as-Code generation using automated validation mechanisms to compute the reward components. The disclosed approach improves accuracy, stability, and efficiency of small language model training while reducing computational cost and inference latency.

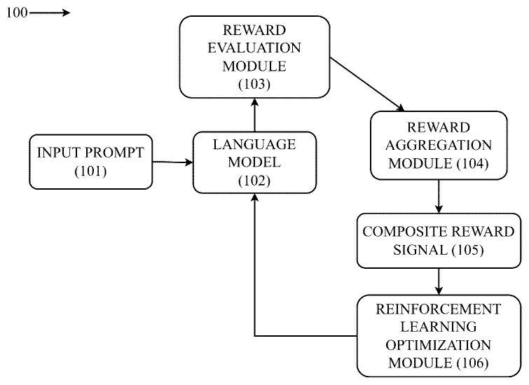

### FIELD OF THE INVENTION

The present disclosure relates generally to the field of artificial intelligence and machine learning, and more particularly to a reinforcement learning system for a resource-constrained language model.

### BACKGROUND

Recent advances in artificial intelligence have led to the widespread adoption of large language models (LLMs) for tasks involving reasoning, code generation, and decision support. In particular, reinforcement learning-based optimization techniques, such as Proximal Policy Optimization (PPO), Group Relative Policy Optimization (GRPO), and Direct Advantage Policy Optimization (DAPO), have demonstrated improved reasoning performance when applied to large-scale models having billions of parameters. However, existing reinforcement learning approaches are predominantly designed for large language models and typically require parameter counts in excess of seven billion. Such models impose significant computational, memory, and energy costs, which can limit suitability for edge deployment, cost-sensitive environments, privacy-critical systems, and on-device inference scenarios. As a result, smaller language models with sub-billion parameter counts have largely relied on knowledge distillation from larger models, which constrains their reasoning capabilities to approximations of the teacher model rather than enabling direct optimization tailored to their limited capacity. Furthermore, known reinforcement learning techniques for language models generally employ sparse or binary reward signals, such as final output correctness or pass/fail evaluation. While effective for large models with substantial representational capacity, such sparse rewards may provide limited training signal resolution for small language models, which in some implementations can be associated with reduced learning stability or generalization. Existing methods, such as GRPO, compute relative advantages among sampled outputs; however, the reward signals in such approaches are not explicitly decomposed into fine-grained or interpretable components, which may limit reward density in certain small-scale optimization scenarios. Additionally, certain existing approaches are not specifically tailored for domain-specific code generation tasks, such as Infrastructure-as-Code (IaC), where strict adherence to syntactic rules, semantic correctness, and structural completeness is often required. Conventional language model training techniques often generate outputs containing explanatory text, malformed syntax, or incomplete configurations, which are unsuitable for direct deployment. Although automated validation tools exist for IaC artifacts, integration of such tools into reinforcement learning reward mechanisms has been limited or application-specific in existing frameworks. Moreover, existing methods such as DAPO introduce enhancements related to clipping strategies, sampling efficiency, and token-level loss normalization; however, these techniques are applied exclusively to large models and do not address the fundamental challenge of enabling small language models to learn complex, multi-step reasoning behaviors using domain-verifiable feedback. The present disclosure addresses challenges related to reinforcement learning optimization in resource-constrained language models, particularly regarding reward signal density, domain-specific verification, and computational efficiency. The present disclosure addresses challenges related to reinforcement learning optimization in resource-constrained language models, particularly regarding reward signal density, domain-specific verification, and computational efficiency.

### SUMMARY

The present disclosure provides a system for reinforcement learning-based optimization of small language models using decomposed reward scoring. The system evaluates generated outputs using multiple reward components corresponding to syntactic correctness, semantic validity, and structural completeness. Each reward component is assigned a predetermined weight, and the weighted reward components are aggregated to produce a composite reward signal that guides parameter updates.

In one embodiment, generated outputs from a small language model are evaluated using a plurality of reward components corresponding to syntactic correctness, semantic validity, and structural completeness. Each reward component is assigned a predetermined weight, and the weighted reward components are aggregated to produce a composite reward signal. The composite reward signal is used to guide reinforcement learning-based updates of model parameters, thereby enabling stable and efficient optimization.

The present invention relates to a system for reinforcement learning-based optimization of language models, and more particularly to the training of small language models using a decomposed, domain-specific reward mechanism. The invention addresses limitations of existing reinforcement learning approaches that rely on sparse or binary reward signals and that are primarily applicable to large language models requiring substantial computational resources.

In accordance with the invention, generated outputs from a small language model are evaluated using a plurality of reward components corresponding to syntactic correctness, semantic validity, and structural completeness. Each reward component is assigned a predetermined weight, and the weighted reward components are aggregated to produce a composite reward signal. The composite reward signal is used to guide reinforcement learning-based updates of model parameters, thereby enabling stable and efficient optimization.

In one embodiment, the reward components are domain-specific and are computed using automated verification mechanisms corresponding to a target domain. In particular, the invention is applicable to Infrastructure-as-Code generation, wherein generated configuration code is evaluated for syntactic validity, semantic correctness of declared resources, and structural completeness required for successful deployment.

In a further embodiment, the reinforcement learning process employs group-based advantage estimation and token-level optimization techniques to ensure effective learning despite the limited representational capacity of small language models. The decomposed reward mechanism provides dense gradient signals that mitigate training instability and reward sparsity.

The invention further enables structured, multi-step reasoning by training the small language model to produce outputs comprising sequential reasoning stages, including analysis, planning, generation, and verification. This structured reasoning improves interpretability, facilitates debugging, and increases trust in the generated outputs.

The disclosed system is configured to enable effective reinforcement learning optimization of small language models using decomposed reward scoring, which may reduce computational cost, inference latency, and energy consumption relative to certain larger-scale implementations.

The invention is not limited to Infrastructure-as-Code generation and may be extended to other structured domains requiring verifiable outputs, without modification to the underlying reinforcement learning framework.

### BRIEF DESCRIPTION OF THE DRAWINGS

The FIGURE illustrates a block diagram of a system for reinforcement learning in resource-constrained language models using decomposed reward scoring

### DETAILED DESCRIPTION

The following description is of exemplary embodiments only and is not intended to limit the scope, applicability, or configuration of the invention in any way. Rather, the following description provides a convenient illustration for implementing exemplary embodiments of the invention. Various changes to the described embodiments may be made in the function and arrangement of the elements described without departing from the scope of the invention.

The FIGURE illustrates a block diagram of a system (100) for reinforcement learning-based optimization of a small language model (102) using decomposed reward scoring. As shown, the system (100) comprises a small language model (102) configured to generate an output in response to an input prompt (101). The generated output is provided to a reward evaluation module (103), which is configured to compute a plurality of reward components, including a syntax reward component representative of syntactic correctness of the generated output, a semantic reward component representative of semantic validity of the generated output, and a structure reward component representative of structural completeness of the generated output. The plurality of reward components is provided to a reward aggregation module (104), which applies predetermined weights to the reward components and aggregates the weighted reward components to generate a composite reward signal (105). The composite reward signal (105) is then supplied to a reinforcement learning optimization module (106), which updates parameters of the small language model (102) based on the composite reward signal (105). In the illustrated embodiment, the small language model (102) is a resource-constrained or small language model (102) having a sub-billion parameter count, and the decomposed reward scoring enables dense training feedback for effective reinforcement learning optimization.

In one embodiment, the invention provides a system for reinforcement learning-based optimization of a small language model (102), particularly a small language model (102) having a sub-billion parameter count. The system (100) is configured to generate outputs in response to input prompts (101) and to iteratively improve the output quality through reinforcement learning driven by decomposed, domain-specific reward signals.

The system (100) comprises a small language model (102), a reward evaluation module (103), a reward aggregation module (104), and a reinforcement learning optimization module (106). These components may be implemented as software modules executed on one or more processors, as hardware modules, or as a combination thereof.

The small language model (102) is configured to receive an input prompt (101) and generate an output sequence. In one embodiment, the small language model (102) is a transformer-based neural network optimized for text or code generation. The small language model (102) is a small language model having fewer than one billion parameters, thereby enabling efficient training and deployment in resource-constrained environments.

The small language model (102) may be pre-trained using supervised learning and subsequently optimized using reinforcement learning as described herein.

The reward evaluation module (103) is configured to receive the generated output from the small language model (102) and to compute a plurality of reward components corresponding to different correctness dimensions of the generated output. The reward evaluation module (103) computes at least a syntax reward component, a semantic reward component, and a structure reward component.

The syntax reward component is representative of the syntactic correctness of the generated output. In one embodiment, the syntax reward component determines whether the generated output conforms to formal syntactic rules associated with a target domain, such as valid configuration syntax, balanced delimiters, or parseable document structure.

The semantic reward component is representative of the semantic validity of the generated output. In one embodiment, the semantic reward component evaluates whether the generated output contains correct entities, operations, or relationships relevant to the task defined by the input prompt (101).

The structure reward component is representative of the structural completeness of the generated output. In one embodiment, the structure reward component determines whether the generated output includes required sections, fields, or hierarchical elements expected for a complete and deployable output.

In a preferred embodiment, the reward evaluation module (103) computes each reward component using automated validation mechanisms corresponding to a target application domain.

The reward aggregation module (104) is configured to apply predetermined weights to each of the plurality of reward components and to aggregate the weighted reward components to compute a composite reward signal (105). The weights assigned to the syntax, semantic, and structure reward components may be fixed or configurable and may be selected to emphasize different correctness dimensions. The predetermined weights are approximately 0.4 for the syntax reward component, 0.3 for the semantic reward component, and 0.3 for the structure reward component, such that syntactic correctness is prioritized while maintaining balanced emphasis on semantic validity and structural completeness.

The composite reward signal (105) provides dense and continuous feedback reflecting partial correctness of the generated output, rather than relying on a binary pass-fail evaluation.

The reinforcement learning optimization module (106) is configured to update parameters of the small language model (102) based on the composite reward signal (105). In one embodiment, the reinforcement learning optimization module (106) employs a policy optimization technique that computes advantage values relative to sampled outputs and performs gradient-based parameter updates.

The reinforcement learning optimization module (106) may further employ group-based sampling, token-level loss normalization, dynamic sampling, or clipping strategies to stabilize training and prevent collapse, particularly when optimizing small language models (102) with limited representational capacity. The reinforcement learning optimization module (106) employs Group Relative Policy Optimization (GRPO), wherein advantage values are computed relative to a group of sampled outputs generated for a given input prompt. The optimization process may further incorporate advanced stabilization techniques, including asymmetric clipping of policy updates, dynamic sampling of non-uniform reward batches, and token-level loss normalization to improve convergence stability and training efficiency, particularly when optimizing small language models with limited representational capacity.

In one exemplary embodiment, the system (100) is applied to Infrastructure-as-Code generation. The input prompt (101) specifies an infrastructure requirement, and the generated output comprises infrastructure configuration code.

The syntax reward component evaluates whether the generated code conforms to the syntax of an infrastructure specification language. The semantic reward component evaluates whether the generated code declares correct resources and configurations. The structure reward component evaluates whether the generated code is complete and deployable. Automated infrastructure validation tools may be invoked to compute one or more reward components, thereby grounding the reward signal in objective, verifiable correctness.

In another embodiment, the system (100) is configured to train the small language model (102) to generate outputs comprising multiple reasoning stages. The generated output may include an analysis stage, a planning stage, a generation stage, and a verification stage. The reward evaluation module (103) may assign reward values based on the correctness of one or more of the reasoning stages.

This embodiment improves the interpretability of the small language model (102) outputs and enables identification of reasoning errors during training and inference.

By decomposing the reward signal into weighted syntax, semantic, and structure components, the system provides dense training feedback that enables effective reinforcement learning optimization of small language models (102). The invention achieves performance comparable to larger models while requiring significantly fewer parameters, reduced computational resources, and lower inference latency.

In certain experimental implementations, application of the disclosed decomposed reward scoring framework to a small language model having approximately 0.5 billion parameters has been observed to produce accuracy values on the order of 97% for selected domain-specific structured generation tasks. Such performance may approach that observed in substantially larger language models in comparable evaluation settings. The invention further enables reliable generation of structured and verifiable outputs, making it suitable for deployment in cost-sensitive, privacy-critical, and edge computing environments.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A reinforcement learning system (100) for a resource-constrained language model, comprising:
a small language model (102) configured to generate an output in response to an input prompt (101);
a reward evaluation module (103) configured to evaluate the generated output by computing a plurality of reward components, the plurality of reward components including:
a syntax reward component representative of the syntactic correctness of the generated output;
a semantic reward component representative of the semantic validity of the generated output; and
a structure reward component representative of the structural completeness of the generated output;
a reward aggregation module (104) configured to apply respective weights to each of the reward components and to compute a composite reward signal (105) based on the weighted reward components; and
a reinforcement learning optimization module (106) configured to update parameters of the small language model (102) based on the composite reward signal (105),
wherein the small language model (102) has a sub-billion parameter count, and
wherein the composite reward signal (105) provides dense training feedback enabling direct reinforcement learning optimization of the small language model (102).

2. The system (100) of claim 1, wherein the reward aggregation module (104) applies predetermined weights of approximately 0.4 to the syntax reward component, 0.3 to the semantic reward component, and 0.3 to the structure reward component when computing the composite reward signal (105).

3. The system (100) of claim 1, wherein the reinforcement learning optimization module (106) employs group-based advantage estimation using Group Relative Policy Optimization (GRPO) by computing relative advantage values among a plurality of sampled outputs corresponding to a common input prompt.

4. The system (100) of claim 1, wherein the reward evaluation module (103) utilizes automated parsing and validation tools to compute one or more of the syntax reward component, semantic reward component, and structure reward component.

5. The system (100) of claim 4, wherein the system is configured for Infrastructure-as-Code generation, and wherein the automated parsing and validation tools include domain-specific infrastructure validation mechanisms to determine deployability of generated configuration code.

6. The system (100) of claim 1, wherein the language model (102) is trained to generate outputs comprising multiple reasoning stages, including analysis, planning, generation, and verification, and wherein at least one reward component is computed based on the correctness of one or more of the reasoning stages.

7. The system (100) of claim 1, wherein the language model (102) comprises approximately 0.5 billion parameters and achieves an accuracy of at least 97%.

8. A method for reinforcement learning-based optimization of a language model, the method comprising:
receiving, by a language model, an input prompt and generating an output sequence in response to the input prompt; and
evaluating the generated output by computing a plurality of reward components, the plurality of reward components comprising:
a syntax reward component representative of the syntactic correctness of the generated output;
a semantic reward component representative of the semantic validity of the generated output; and
a structure reward component representative of the structural completeness of the generated output.

9. The method of claim 8, further comprising applying respective weights to each of the plurality of reward components and aggregating the weighted reward components to compute a composite reward signal.

10. The method of claim 9, further comprising updating parameters of the language model based on the composite reward signal using a reinforcement learning optimization process.

11. The method of claim 8, wherein the language model is a small language model having a sub-billion parameter count.

12. The method of claim 8, wherein the composite reward signal provides dense training feedback enabling direct reinforcement learning optimization of the small language model.
